(19) United States
(12) Patent Application Publication
(10) Pub. No.: US 2026/0216775 A1
(43) Pub. Date: Jul. 30, 2026

(54) Hot Straightening Device for the Hot Straightening of a Component and Hot Straightening Process

(71) Applicant: Core 12 GmbH, Herrsching am Ammersee (DE)

(72) Inventor: Christian Platzer, Graz (AT)

(21) Appl. No.: 19/148,615

(22) PCT Filed: Jan. 18, 2024
(86) PCT No.: PCT/EP2024/051104

§ 371 Date: Jul. 16, 2025

(30) Foreign Application Priority Data
Jan. 18, 2023 (DE) 10 2023 101 164.2

(51) Int. Cl. B21D 3/10; B21D 37/16

(52) U.S. Cl. CPC B21D 3/10; B21D 37/16

(57) ABSTRACT

The invention relates to a hot straightening device for hot straightening a component (B), wherein the hot straightening device comprises the following: a pressing tool (1) which is designed to accommodate the component (B) and to apply at least one straightening force (F₁, F₂, F₃) to it and to deform it, in particular to correct local component nominal dimension deviations, and at least one component heating element (2) which is designed and arranged to heat the component (B) within the pressing tool (1) to a straightening temperature (Tᵣ) without contact.

The invention relates to a hot straightening device for hot straightening a component according to the subject matter of claim 1 and a hot straightening method according to claim 16.

In all industrial component manufacturing processes, various process fluctuations inevitably occur in the course of a manufacturing process, which can manifest themselves in comparatively small but possibly highly unfavorable dimensional deviations of the components. These fluctuations essentially affect all components, such as metal components, die-cast components (metal or plastic), 3D printed components or even forged parts.

Possible process fluctuations are, for example, temperature differences in a production hall at different times of the day and/or year or in different areas of the production hall. In addition, process fluctuations (e.g. due to fluctuations in the heating) can also occur in casting processes or metal injection molding processes (e.g. thixomolding). Differences in humidity can also lead to dimensional deviations in the components. In addition to these influences of the environment, influences of the production system (such as an injection molding system or similar) are also relevant for dimensional deviations of the components to be produced. Such fluctuations can be caused by continuous tool wear, fluctuations in the hydraulics, etc. In casting processes, component shrinkage (volume difference of the liquid metal compared to the solid component) is an inherent problem. The shrinkage is blocked by the casting mold and results in residual stresses in the component. At the same time, component shrinkage can also vary according to the geometry of the component (as, for example, thick areas shrink differently relative to thin areas), which further exacerbates a problem with regard to residual stresses in the component.

Nowadays, metal display holders or laptop housings are increasingly manufactured using die casting or metal injection molding processes. High-precision dimensional accuracy is required for such components, as displays, for example, are often mounted to the component using an adhesive bond. Dimensional deviations on a display holder, caused by the process fluctuations described above, can therefore lead to optical distortion of the image or make installation more difficult or even impossible. Even when installed, tensile forces in the bonded display can cause problems during subsequent operation. During operation (e.g. temperature difference summer/winter in the car interior or vibration caused by moving the vehicle), tensions can be released in the holder and exert additional forces on the display. Possible consequences are the development of the moiré effect on the display or, in the worst case, breakage of the display glass.

Due to the increasing demand for such components and the simultaneously increasing requirements with regard to the precision of component dimensions and their tolerances, such components can sometimes no longer be produced (economically) using a single primary process, such as die casting or metal injection molding.

AT 516 761 B1 describes that after casting a metallic component, the shape of the component often deviates slightly from the desired final shape. To solve this, AT 516 761 B1 suggests holding the component in a defined position and measuring its geometry. The direction in which and the amount by which the geometric dimensions of the component deviate from the stored nominal dimensions is then calculated in order to correct this deviation using straightening punches.

However, such a method as described in AT 516 761 B1 is comparatively time-consuming, as measuring and straightening of the component are carried out iteratively. In addition, only a slight change in the shape of the component is possible with such “cold straightening”, so that in step d) described in AT 516 761 B1, a component is defined as a reject if it is determined that the dimensional deviations are too large to be corrected by the described straightening.

Overall, “cold straightening” is therefore considered to be in need of improvement, as only minor changes in shape are possible here, for which comparatively high forces are required. In addition, such a method requires overbending of the component region to be corrected, as an elastic part must be bridged during straightening. This always requires an iterative process, as each initial dimension must be pressed differently. This repeated overbending can lead to the formation of cracks in the component. Residual stresses also remain (or arise) in the component with this type of method. This is particularly disadvantageous where the component is later exposed to high temperatures and temperature fluctuations during use, such as in a vehicle interior, where fluctuations between −30° C. and 80° C. occur regularly. Such temperature fluctuations can deform the component under tension. In the case of a component used as a display holder in a vehicle, for example, these stresses can ultimately severely impair the image quality of the display or cause the display to crack.

A well-known approach for flat or easily twistable structural components, which enables major changes in shape in a straightening process, is hot straightening. In this process, the component is strongly heated by heating cartridges in a holding area of conventional straightening machines in order to facilitate deformation. However, these systems are comparatively slow and inefficient, as the entire machine bed is heated with such heating cartridges and the heating power is comparatively low. In addition, uniform heating of components with a more complex geometry (such as curved components, e.g. a holder for a “curved display”) is hardly possible, as heat transfer to the component depends on the bearing surface (contact surface) between the component and the straightening punch (heat conduction). In an extreme case, only one edge of the component would be actively heated, while the rest of the component is not actively heated and is therefore initially cooler than the heated area of the component. Pressing may increase the contact surface between the component and the straightening machine and thus also the heat transfer to the component, so that a coupling is created between heating the component and a straightening force exerted on the component. This means that the process cannot be optimally controlled and further contributes to inhomogeneous heating of the component. This inhomogeneous heating of the component can also lead to different thermal expansions during the straightening process, which results in stresses in the component that have already been described above as disadvantageous in connection with cold straightening.

Particularly in the case of (die-cast) components, such as components made of a magnesium- and/or aluminum-containing alloy, a comparatively low modulus of elasticity can lead to comparatively low stresses generating considerable elastic distortions of the component.

The invention is therefore based on the object of further developing a hot straightening device and a hot straightening method in such a way that the above-mentioned disadvantages are avoided. In particular, the object of the invention is to further develop the known concepts for straightening components in such a way that a particularly reliable dimensional accuracy of the components can be ensured and simple and fast component processing can be provided.

This object is solved by a hot straightening device according to claim 1 and a hot straightening method according to claim 12.

In particular, the object is solved by a hot straightening device for hot straightening a component, in particular a cast part, wherein the hot straightening device has the following:
a pressing tool which is designed to accommodate the component and to apply a straightening force to it and to deform it, in particular to correct local component nominal dimension deviations, and
at least one component heating element which is designed and arranged to heat the component within the pressing tool to a straightening temperature without contact.

A fundamental idea of the invention is to heat a component in the pressing tool in a controlled manner by decoupling the transmission of force to the component and the heating of the component. In this way, distortion of the component can be avoided, since the components are kept largely free of residual stresses during straightening, and residual stresses from upstream processes can even be reduced. In the present hot straightening device or in the corresponding hot straightening method, the component is heated to a corresponding straightening temperature during the straightening process, which is advantageous for plastic deformation of the component material. Preferably (depending on the material and its material thickness), this is a temperature in the range of stress relief annealing of the component material (depending on the material and material properties, however, other temperatures or temperature ranges are also conceivable, which are advantageous for plastic deformation of the component). In this way, it is possible to ensure that the components are essentially free of residual stress during and in particular also after straightening or that the residual stresses can be reduced so that the dimensional stability of the component is also ensured in the long term and the components do not warp. This heating of the components according to the invention should in particular not depend on a contact surface (e.g. bearing surface of the component in the pressing tool) between the component and the pressing tool, so that the heating is essentially independent of a component geometry, i.e. that even more complex component geometries, such as e.g. curved components (which may only rest with one edge), can be heated uniformly.

A “component” is understood here in particular to be a cast part or cast component, i.e. a component that has been produced by a casting process, such as a cold chamber die casting process, a hot chamber die casting process or a thixomolding process.

In this context, “hot” or “hot straightening” means that the temperature is preferably in the stress-relief heat treatment range of the material. The corresponding temperature range naturally varies depending on the material. Preferably, this should be understood to mean a temperature range of approx. 30 to 60% of the melting temperature range of the material used. In particular, hot straightening according to the invention drastically reduces a proportion of the elastic deformation (compared to cold straightening), so that cracking can be avoided.

In the context of this application, “non-contact heating” is understood to mean that the heating of the component does not take place by direct or indirect contact or a contact surface between the heating element and the component (i.e. is not based on heat conduction), but that the heating takes place in particular via a heating element spaced apart from the component (wherein the proportion of natural convection is or should be negligible).

With regard to the fact that the pressing tool is designed in particular to correct local deviations in component dimensions, it is understood that the pressing tool is preferably designed in such a way that different straightening forces can be applied in certain component regions. For this purpose, the pressing tool can be segmented accordingly and/or have individually controllable straightening rams.

In one possible embodiment, the pressing tool is moved hydraulically or servo-electrically. Alternatively or additionally, the pressing tool is moved in a force-controlled and/or displacement-controlled manner. Preferably, the pressing tool includes a displacement measuring system and/or a force measuring system for this purpose. This makes component processing particularly precise and dimensionally accurate.

Alternatively or additionally, the pressing tool has a segmentation, preferably in such a way that different straightening forces can be applied in certain component regions. For example, individually driven straightening rams can be provided for this purpose, which can be moved hydraulically or servo-electrically. This can also make processing more precise and increase the dimensional accuracy of the component.

It is also conceivable that the pressing tool is designed as a (partial) negative mold of the nominal contour of the component.

In one embodiment, the at least one straightening punch is at least partially designed as a negative mold of the nominal contour of the component. For example, it is conceivable that the straightening punch is designed as an upper half of the negative shape of the nominal contour and corresponds to a lower half of the negative shape.

The pressing tool can also be configured in such a way that areas of the negative mold are designed (dimensioned) to allow for component shrinkage during cooling. A “springback effect” can be countered by deforming the component in this way. For this purpose, the negative shape can deviate (locally) from the nominal contour of the component, in particular in such a way that a subsequent cooling process is taken into account, so that the nominal contour is reached after cooling (in particular to approximately room temperature). In this way, a difference between a hot straightening geometry and a nominal contour can be minimized.

In a preferred embodiment, the component may comprise an alloy comprising (or consisting of) substantially 91 wt. % magnesium and 9 wt. % aluminum. However, the process described herein is not limited to a specific material selection, but can in principle be applied to all materials that can be used to produce a (cast) component.

In one embodiment, the at least one component heating element comprises an electromagnetic heating element. This allows the component to be heated efficiently and quickly.

With an induction heating element, the (metallic) component can be heated extremely quickly by coupling electromagnetic radiation or waves directly into the component, which can shorten the cycle time of the process. An induction heating element makes it possible to generate heat directly in the component. This also makes it possible to heat the component evenly (and in particular essentially independently of the component geometry). The environment is not heated, but (only) the component, so that process efficiency is also increased.

In this way, heating can also only take place in specific areas, e.g. where straightening is required or desired.

It is also possible for the induction heating element to be designed to generate different induction frequencies. Depending on the induction frequency used, heating can take place either on the surface or in the volume of the component. Depending on the straightening geometry and/or material properties of the component, this can lead to considerable improvements in dimensional accuracy. Overall, this also makes the hot straightening device more flexible in its application.

In one embodiment, the at least one component heating element comprises a radiant heater or a monochromatic radiation source, in particular a laser source.

According to one embodiment, a radiant heater may comprise an infrared source which is directed towards the component or towards a component region. In an alternative embodiment, a heat radiator can also comprise a hot air blower that is directed at the component or at a component region.

Such a radiant heater can also heat the component very quickly and in a targeted manner so that the component can be heated evenly.

A combination of induction heating element and radiant heater (e.g. for different component regions) is also conceivable for components with a particularly complex geometry in order to heat the component evenly.

Using a monochromatic radiation source, such as a laser source, a component can be heated particularly quickly and precisely, for example in small areas and/or on edges.

This embodiment also makes it possible to heat and shape non-metallic materials (or materials that cannot be heated by induction) accordingly. This makes the hot straightening device versatile, as it is not limited to specific material properties.

Alternatively or additionally, non-contact heating can also be supported by appropriately arranged and designed heating cartridges or the like (or possibly also at least partially or temporarily independently).

Overall, the uniform heating of the component can improve the dimensional accuracy of the component, as residual stresses are reduced and avoided during straightening. On the other hand, individual areas can also be heated in a targeted manner. This can increase process efficiency.

In one embodiment, the hot straightening device comprises at least two component heating elements, which are designed and arranged in such a way that a first component region can be heated to a first temperature and a second component region to a second (or a further) temperature. In this way, the component can be heated in a spatially resolved manner. This is advantageous, for example, for components that have different wall thicknesses in different areas. Despite the different amounts of material in these areas, this enables the component to be heated evenly, for example by heating the area with a greater wall thickness more than the area with a lesser wall thickness. This further improves the dimensional accuracy of the component.

In one embodiment, the hot straightening device comprises at least one cooling device which is designed to (actively) cool the component or a component region. In particular, active cooling can be achieved by flushing the component or a component region with (compressed) air.

In this way, it is possible to cool the component in a controlled manner before removing it from the pressing tool in order to prevent the component from warping or building up internal stresses during rapid, uncontrolled cooling (quenching). Previously more strongly heated areas (if heating was carried out in this way) can be cooled more strongly (e.g. by a higher volume flow) so that uniform cooling is possible in order to avoid stresses in the component. Another advantage is work safety, as a cooled and not a hot component must be removed.

Alternatively, the component can also be cooled in air if the quality criteria permit this.

In one embodiment, the pressing tool comprises at least one straightening punch, wherein the at least one component heating element and/or the cooling device are arranged inside the at least one straightening punch.

Alternatively or additionally, the at least one component heating element (or a further component heating element) may be insertable (e.g. pivotable) into the pressing tool. Preferably, the pressing tool or the hot straightening device is designed in such a way that the at least one component heating element is pivoted into the open pressing tool. For example, the hot straightening device can have an insertion device (e.g. a swivel arm) for this purpose. The hot straightening device is preferably designed such that the at least one straightening punch can move up and down in sections (i.e. sections or straightening rams on the straightening punch designed as extensions) between and/or through the at least one (inserted) component heating element (so that when the pressing tool is closed, the component heating elements are penetrated by the sections of the straightening punch and the component is subjected to a straightening force after or during this penetration).

In this way, the component heating element can be brought comparatively close to the component to enable efficient heating. The corresponding arrangement also enables the component to be heated evenly. Overall, this further improves the hot straightening process.

In one embodiment, the pressing tool or the at least one straightening punch is formed from a non-electrically conductive material at least in some regions (i.e. in particular in regions in which the at least one component heating element is arranged) and/or in regions in the vicinity of the at least one component heating element. The electrically non-conductive material may, for example, comprise ceramic or a mineral or plastic. A plastic material can also be reinforced, e.g. reinforced with glass fibers or other (mineral) fibers or additives.

In particular for an induction heating element as a component heating element, this design can increase the efficiency of the hot straightening device according to the invention, as the eddy currents generated by the inductor are not absorbed in the electrically non-conductive material and it is therefore not heated. In this respect, the heating is limited to the exact location of the (metallic) component, which improves the efficiency and homogeneity of the heating. Precise and efficient heating of the component also reduces the straightening force.

In one embodiment, the hot straightening device comprises at least one control unit which is designed to control a component temperature or the at least one component heating element and/or the cooling device via a determinable temperature-time function T(t) (i.e. a temperature curve over time), in particular in order to heat and/or cool the component (B).

This makes it possible to control the heating of the component with a defined development or function of the component temperature and, in particular, independently of a straightening force. For example, a decreasing temperature can be realized during an increasing or constant straightening force. This improves the accuracy of the heating and stresses in the component can be avoided in a controlled manner.

In a further development of the invention, the hot straightening device can also have one or more temperature sensors (one temperature sensor per component heating element is also conceivable, for example) in order to control a (local) component temperature or a (local) component temperature curve (using the component heating element or the component heating elements) in a controlled manner.

This can ensure that the component or the component regions have the optimum temperature conditions, e.g. that a temperature is present in a stress-relief heat treatment area of the component material at a certain point in time, e.g. in order to apply maximum straightening force only then. This further improves the accuracy of the heating process and stresses in the component can be avoided in a controlled manner.

In one embodiment, a/the control unit (of the hot straightening device) is designed to control the at least one straightening force of the pressing tool via a determinable force-time function F(t) (i.e. a force curve over time) and/or at least one straightening path S(t).

This allows a controlled straightening force to be applied to the component in order to deform or straighten it in a controlled manner. Overall, this further improves the dimensional accuracy of the component.

In one embodiment, a/the control unit (of the hot straightening device) and/or the hot straightening device is/are designed to measure the component during and/or after straightening (e.g. mechanically and/or optically). This makes it possible to (automatically) detect areas for rectification and/or carry out controlled straightening. Overall, the precision of the processing and the dimensional accuracy of the component can be improved as a result.

In one embodiment, the hot straightening device (and/or the pressing tool) is designed to exert a vibration on the component. For example, the force-time function F(t) can have a (high-frequency) oscillating (e.g. sinusoidal) curve, e.g. with a frequency of 0.01 Hz to 10 MHz. In a possible further development, the hot straightening device can be designed to exert a vibration on the component in a plane normal (perpendicular) to a straightening force axis, preferably in such a way that the vibration is superimposed on the straightening force.

The vibrations accelerate the diffusion of the metal atoms and thus the stress relief in the component (by shaking the component), so that the risk of the component warping under residual stress after the straightening process is minimized as far as possible. This further improves the dimensional accuracy—especially long-term dimensional accuracy—so that the component does not warp due to internal stress later on at a customer (e.g. in a vehicle under temperature fluctuations). For example, depending on the requirements and/or component geometry, vibration can be exerted perpendicular and/or parallel to a straightening force axis. This makes the hot straightening device comparatively flexible and the residual stress relief can be adapted accordingly to the respective component.

In one embodiment, the hot straightening device has a modular design. It can be inserted into an (existing) pressing machine (such as a punching machine or the like) so that the pressing force of the pressing machine can be used for hot straightening.

This makes the hot straightening device according to the invention comparatively inexpensive and flexible to handle. In addition, companies can easily and quickly retrofit their existing pressing machines. It has even proved possible for the punching tool used in each casting cell to be used as a hot straightening tool at the same time, allowing punching and hot straightening to be carried out in a single process step and thus further reducing costs.

In one embodiment, the hot straightening device can also be designed to accommodate an already heated or still warm component (whose heat comes from an upstream process step) and further increase or maintain its temperature. In this way, the efficiency of the straightening process can be further increased and the manufacturing process accelerated.

In particular, the object according to the invention is also solved by a method for hot straightening a component, preferably a casting, in particular using a hot straightening device as described above, wherein the hot straightening method comprises the following steps of:
a) introducing a component into a pressing tool,
b) non-contact heating of the component to a straightening temperature,
c) applying a straightening force to the component in order to deform the component, in particular to correct local deviations in component dimensions,
d) optional cooling of the component in an open or closed state of the pressing tool,
e) removal of the straightened component.

The same advantages can be achieved with the hot straightening method according to the invention as have already been described in connection with the hot straightening device according to the invention. It should be noted that the features described in the context of the hot straightening device according to the invention also apply to the hot straightening method according to the invention. Features of the hot straightening device are transferable to the hot straightening method according to the invention. Likewise, features or steps of the hot straightening method are transferable to the hot straightening device in that the hot straightening device has appropriately configured means for carrying out these features or steps.

In one embodiment, step b) comprises heating the component electromagnetically, in particular by induction. As already described above, this offers the advantage of heating the component comparatively quickly and efficiently and with pinpoint accuracy.

It is possible for step b) to be carried out before or after step c). Alternatively, steps b) and c) can be carried out substantially simultaneously. This makes the method more flexible. Depending on the material or material properties, alternating the sequence of heating and straightening can have a positive effect on dimensional accuracy.

In one embodiment, the component to be straightened is a metallic die-cast component, in particular comprising an aluminum alloy and/or a magnesium alloy. In a preferred embodiment, the component may comprise an alloy comprising (or consisting of) substantially 91 wt. % magnesium and 9 wt. % aluminum.

In one embodiment, a cycle time from step a) to e) is less than 120 seconds, preferably less than 60 seconds, more preferably less than 10 seconds. The efficient heating of the component according to the invention makes it possible to keep the cycle time of the straightening process comparatively short. Such a fast straightening process allows production processes to be optimized and production costs to be saved.

In one embodiment, a component temperature is controlled via a predetermined or determinable temperature-time function T(t) and/or the straightening force of the pressing tool is controlled via a predetermined or determinable force-time function F(t) and/or the straightening path of the pressing tool is controlled via a predetermined or determinable path-time function or straightening path S(t) (or optionally controlled using corresponding sensors).

In this way, the straightening force, straightening path and temperature of the hot straightening process can be controlled independently of each other and in a controlled manner. Straightening force, straightening path and temperature can be combined in any amount and duration in this way. This increases the flexibility of the straightening process. For example, rapid heating of the component can be achieved independently of force, convection and heat conduction. This reduces residual stresses in the component and minimizes the possibility of residual stresses building up during straightening. Overall, this improves the (long-term) dimensional accuracy of the component.

In one embodiment, the component is heated in such a way that the straightening temperature is reached at an initial point in time before the straightening force reaches its maximum. This reduces the required straightening force so that the method can also be realized with comparatively low closing forces of less than 10 t.

In one embodiment, the component is cooled at a second point in time before the straightening force at the end of straightening (end of step c)) becomes minimal and the component is actively cooled to a removal temperature, and/or the removal temperature of the component is less than 1/10 of the maximum straightening temperature or the recrystallization temperature.

It is possible that the removal temperature essentially corresponds to a room temperature (or ambient temperature), in particular between 15° C. and 45° C., preferably between 20° and 35° C. Alternatively, removal can take place at 100° C. and below (e.g. as soon as a recrystallization process has been completed).

By actively cooling the component in the pressing tool, residual stresses are relieved in a controlled manner (and not abruptly) and independently of external influences. In this way, the desired geometry is fixed in the structure (the residual stresses resulting from the material shrinkage are frozen). This prevents the component from warping uncontrollably after the straightening process (e.g. when the hot component is removed and cools down uncontrollably). This also increases work safety, as the component can be removed by hand in a safe manner.

In one embodiment, an initial temperature of the component essentially corresponds to a room temperature, in particular between 15° C. and 35° C., preferably between 20° and 25° C. Alternatively or additionally, the straightening temperature is between 30% and 60% of a melting temperature range of the material of the component. Alternatively or additionally, the straightening temperature is between 190° C. and 450° C., preferably between 250° C. and 330° C., more preferably between 210° C. and 310° C.

This allows the material to be plastically deformed and dimensional accuracy to be precisely maintained. (Residual) stresses in the material are reduced in this temperature range (stress relief annealing). In addition, comparatively low straightening forces of less than 10 t can be implemented.

In one embodiment, step c) comprises exerting a vibration, in particular a high-frequency vibration, on the (heated or cooled) component, preferably towards the end of step c), in particular during a decreasing straightening force (F) towards the end of step c). The vibration reduces residual stresses in the component (by shaking the component), so that the risk of the component warping under residual stress after the straightening process is minimized as far as possible. This further improves the dimensional accuracy—in particular long-term dimensional accuracy—so that the component does not warp due to residual stress later on at the customer (e.g. in a vehicle under temperature fluctuations).

Further advantageous embodiments are shown in the subclaims.

In the following, the invention is also described with regard to further details, features and advantages, which are explained in more detail with reference to the figures. The features and combinations of features described, as shown below in the figures of the drawing and described with reference to the drawing, are applicable not only in the combination indicated in each case, but also in other combinations or in a sole position, without thereby departing from the scope of the invention, wherein:

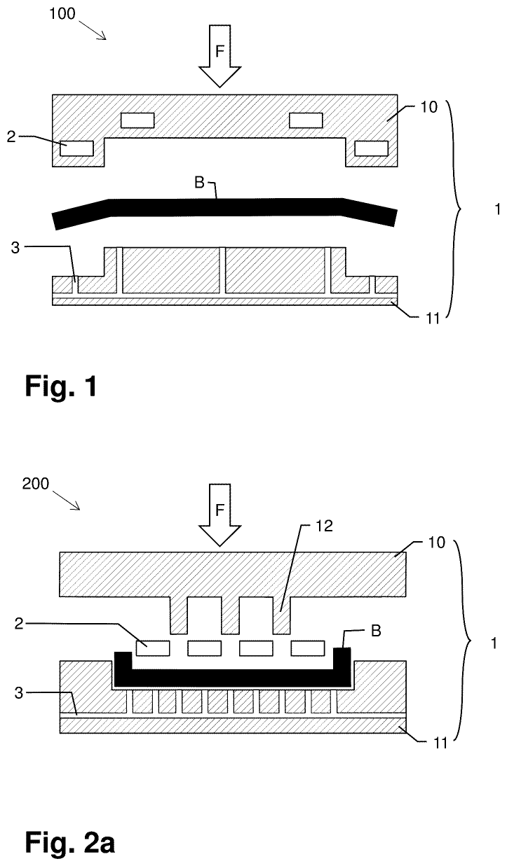

FIG. 1 shows a first embodiment of a hot straightening device according to the invention;

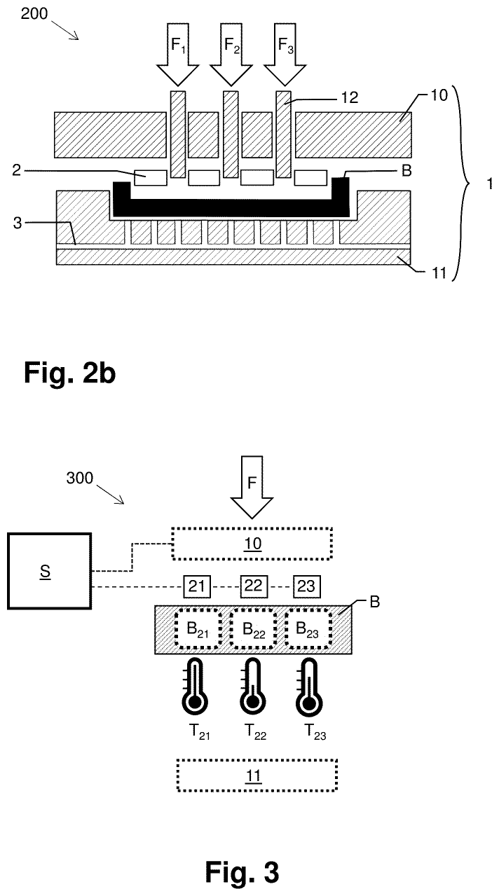

FIG. 2a shows a second embodiment of a hot straightening device according to the invention;

FIG. 2b shows a possible variant of the second exemplary embodiment with individually controllable straightening rams;

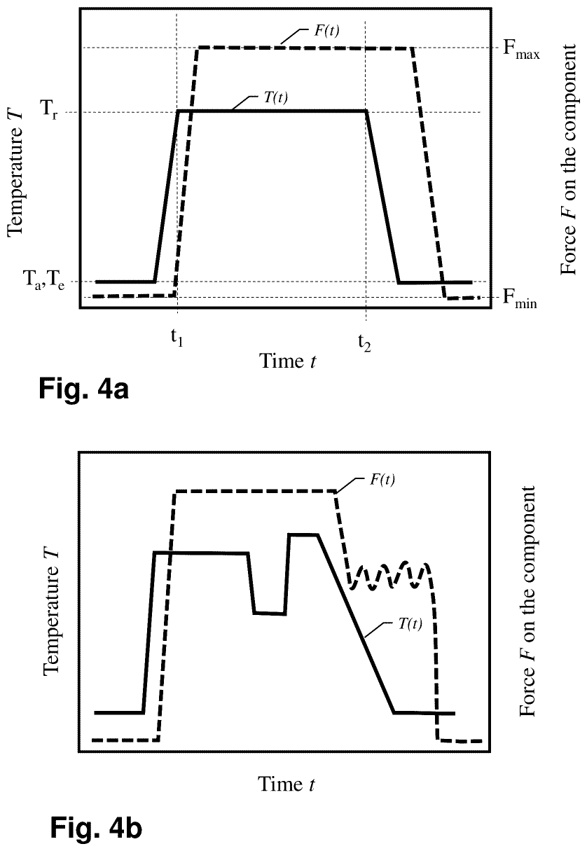

FIG. 3 shows a schematic view of a component within a hot straightening device according to the invention according to an exemplary embodiment;

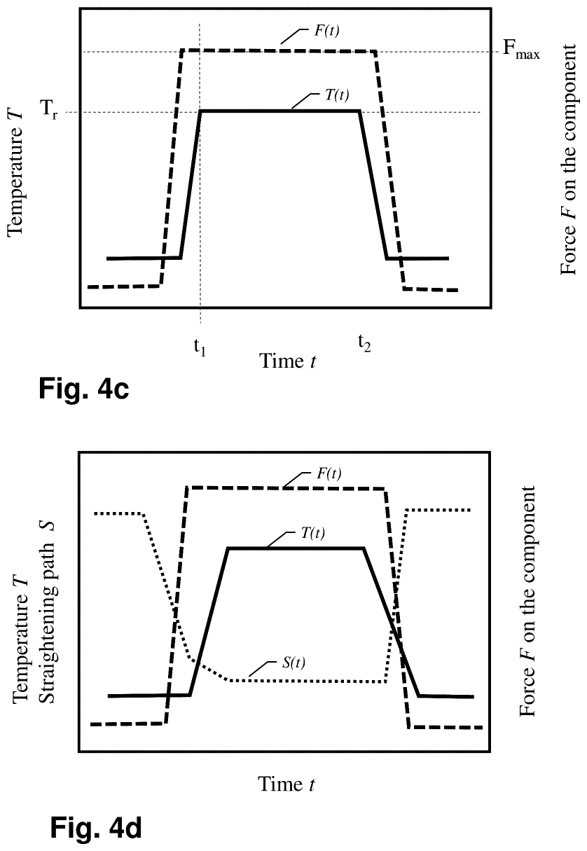

FIG. 4a shows an exemplary embodiment for a temperature-time function T(t) for controlling a component temperature and for a force-time function F(t) for controlling the straightening force of a hot straightening method according to the invention;

FIG. 4b shows an alternative exemplary embodiment for a temperature-time function T(t) for controlling a component temperature and for a force-time function F(t) for controlling the straightening force of a hot straightening method according to the invention;

FIG. 4c shows a further exemplary embodiment for a temperature-time function T(t) for controlling a component temperature and for a force-time function F(t) for controlling the straightening force of a hot straightening method according to the invention;

FIG. 4d shows a further exemplary embodiment for a temperature-time function T(t) for controlling a component temperature, for a force-time function F(t) for controlling the straightening force and for a path-time function or a straightening path S(t) of a hot straightening method according to the invention.

The figures are merely schematic in nature and are provided solely for the purpose of understanding the invention.

FIG. 1 shows a first exemplary embodiment of a hot straightening device 100 according to the invention. FIG. 1 shows a schematic cross-section through the hot straightening device 100.

The hot straightening device 100 has a pressing tool 1. The pressing tool 1 is designed to receive a component B and hold it on a component bed 11. The component bed 11 can have appropriately arranged support points (not shown) for this purpose.

The component B is, for example, a die-cast component made of an alloy comprising magnesium and/or aluminum. In one exemplary embodiment, it can be a curved component, such as a “curved display” holder. For example, the component B has been manufactured in an upstream injection molding process, wherein this upstream process does not provide sufficient accuracy to the dimensional accuracy requirements of the component B.

The pressing tool 1 is configured to apply a straightening force F to the component B so that the component B is deformed, in particular to correct local deviations in the nominal dimensions of the component B in order to bring the component B to the nominal dimensions.

The component B is subjected to a straightening force F by (e.g. hydraulic or servo-electric) closing of the pressing tool 1 and is brought to its nominal dimensions by the contour of at least one straightening punch 10 and/or the component bed 11.

A plurality of component heating elements 2 are arranged inside the pressing tool 1.

According to one exemplary embodiment, the component heating elements 2 are designed as induction heating elements 2. Preferably, the induction heating elements 2 each comprise an induction coil.

The induction heating allows the component B to be heated precisely to a temperature that has a beneficial effect on the straightening process.

An advantageous straightening temperature depends on the material to be straightened and the material thickness—for metallic components, a temperature range for stress-relief annealing is preferred. This temperature can be approximately 30-60% of the melting temperature range of the material.

In the case of component B, which according to one example consists of an alloy containing magnesium and/or aluminum (such as AZ91), a temperature of approximately 260° C. over a period of one hour is required to stress-relieve a component. The period can be roughly halved by increasing the temperature by 10° C. (i.e. 30 minutes at 270° C., 15 minutes at 280° C., etc.).

In one exemplary embodiment, the component (depending on the thickness of the component B) is heated to a component temperature of between 190° C. and 450° C., preferably between 250° C. and 330° C., more preferably between 270° C. and 310° C., for a certain period of time.

In a further development, the pressing tool 1 can be made entirely or in the vicinity of the component heating elements 2 from non-conductive material. In the case of induction heating elements 2, this has the advantage that only the component B and not the pressing tool 1 is heated in order to improve the efficiency and speed of heating.

After or during the heating of the component B, the pressing tool 1 can exert a straightening force F on the component B in order to correct local deviations in the nominal dimensions of the component B and thus bring the component B to the nominal dimensions.

For controlled cooling of the component B, the hot straightening device 100 has a cooling device 3. According to one example, the cooling device 3 can be arranged in the component bed 11. In general, the cooling device 3 can be designed to cool the component bed with a (cooling) fluid.

The cooling device 3 preferably comprises one or more flow channels (in the component bed 11) through which (pressurized) air or another process gas or a liquid can be passed to cool the component B. In particular, in such a way that the air or the process gas or a liquid flows from the flow channels directly onto the component B.

As an alternative (or in addition) to flow channels for (compressed) air or the like, the pressing tool 1 can also have a coolant circuit (not shown) as a cooling device 3. This can, for example, be arranged in the component bed 11 for cooling the component B.

The hot straightening device 100 is not limited to the arrangement of heating elements 2 and cooling device 3 shown in FIG. 1. The arrangement shown serves only to illustrate the principle according to the invention. For example, it is also conceivable to integrate both the cooling device 3 and the component heating elements 2 in the straightening punch 10 and/or in the component bed 11. Alternatively, the component heating elements 2 can also be arranged in the component bed 11 and the cooling device 3 in the straightening punch 10.

It is also conceivable that the hot straightening device 100 only has a single component heating element 2. For example, an appropriately shaped and arranged induction coil 2.

A drive concept on which the pressing tool 1 is based is not necessarily specified. The pressing tool 1 can be designed in such a way that a first straightening punch 10 and the component bed 11 form a (fixed) negative shape of the component B (e.g. as shown in FIG. 1).

FIG. 2a shows an alternative exemplary embodiment of a hot straightening device 200 according to the invention.

The hot straightening device 200 essentially differs from the hot straightening device 100 in that the component heating elements 2 are not arranged within the straightening punch 10.

According to this exemplary embodiment, the component heating elements 2 can be inserted into the pressing tool 1, e.g. in that the hot straightening device 200 having a heating element holding device (not shown), on which the component heating elements 2 are arranged, and which can be introduced into the open pressing tool 1, for example by swiveling in or pushing in the heating element holding device.

The hot straightening device 200 is designed and arranged in such a way that the at least one straightening punch 10 can be moved up and down at least in sections between and/or through the at least one inserted component heating element 2.

According to one example, the pressing tool 1 of the hot straightening device 200 has an upper straightening punch 10 for this purpose, which has a plurality of straightening rams 12. The straightening rams 12 can move up and down between the (inserted) component heating elements 2. The straightening rams 12 can thus apply a straightening force F to the component B and deform it, in particular to correct local deviations in component dimensions.

In one exemplary embodiment, the straightening rams 12 are made of a non-conductive material in order to optimize the efficiency of the heating process when using induction component heating elements 2.

In a possible further development of the hot straightening device 200, each straightening ram 12 has its own separately controllable drive in order to apply different straightening forces F₁, F₂, F₃ to different positions, see FIG. 2b.

In this way, the hot straightening device 200 is designed to control the straightening rams 12 with different straightening forces F₁, F₂, F₃ in order to deform the component B locally in different ways.

For the explanations of the cooling device 3, please refer to the explanations of the exemplary embodiments according to FIG. 1.

The hot straightening devices 100, 200 can be designed as presses which have a hydraulic or servo-electric drive, for example, in order to apply a straightening force F to the component B by closing the pressing tool 1.

Alternatively, however, it is also conceivable to form the hot straightening devices 100, 200 in a modular fashion. For this purpose, the straightening punch 10 can, for example, have a corresponding (not shown) mounting device in order to be connected to a punch of a punching machine or the like in order to use the pressing force of the punching machine or the like.

In a further exemplary embodiment of a hot straightening device 300 according to the invention, it comprises a control unit S. A diagram of this exemplary embodiment is shown in FIG. 3.

The hot straightening device 300 is designed in the same way as the hot straightening devices 100, 200 previously described in connection with FIG. 1 and/or FIG. 2a, b.

The control unit S can, for example, be designed as a computing unit such as a computer or can also be designed as a microcontroller.

The control unit S is designed to control the component heating elements 21, 22, 23 and/or to control the at least one straightening punch 10 (or the straightening rams 12, see FIG. 2a,b). The straightening rams 12 can optionally be controlled individually. The number of component heating elements 21, 22, 23 shown in FIG. 3 is not limited to three.

By separately controlling the component heating elements 21, 22, 23, component regions B₂₁, B₂₂, B₂₃ of the component can be heated to different component temperatures T₂₁, T₂₂, T₂₃.

This can be advantageous, for example, for different component thicknesses in the component regions B₂₁, B₂₂, B₂₃.

In a possible further development, the hot straightening device 300 or the control unit S comprises a displacement measuring system so that the component B can be deformed up to predefined nominal positions.

In addition, the control unit S can be used to control the component heating elements 21, 22, 23 via a temperature-time function T(t) to control a component temperature (in a component region) and for a force-time function F(t) to control the straightening force F or straightening position (possibly in a component region).

This is shown by way of example in FIG. 4a for a die-cast component B made of a magnesium- and/or aluminum-containing alloy.

According to an exemplary embodiment for a hot straightening method according to the invention with the temperature-time function T(t) and for a force-time function F(t) according to FIG. 4a (using a hot straightening device 100, 200, 300), the component B or a component region B₂₁ is heated.

In a preferred embodiment of the hot straightening method, the component B has an initial temperature Tₐ which essentially corresponds to a room temperature. In particular, this is a temperature that is roughly between 15° C. and 45° C.

In this embodiment, the straightening temperature Tᵣ is reached in at least one (heated) area of the component B at a first time t₁ before the maximum straightening force Fₘₐₓ is applied.

The straightening temperature Tᵣ is preferably within a temperature range for stress relief annealing of the component material, for example in a temperature range of approx. 30 to 60% of the melting temperature range of the material used. In order to stress-relieve the component, this temperature/temperature range should be maintained for a certain period of time.

In the case of component B, which according to one example consists of an alloy containing magnesium and/or aluminum (such as AZ91), a temperature of approximately 260° C. over a period of one hour is required to stress-relieve a component. The period can be roughly halved by increasing the temperature by 10° C. (i.e. 30 minutes at 270° C., 15 minutes at 280° C., etc.).

If, according to one example, component B is heated to a straightening temperature Tᵣ of approx. 310° C. at time t₁, this temperature Tᵣ is maintained for approx. 2 minutes between times t1 and t2 in order to anneal the component with low stress. The above-mentioned example of a straightening temperature Tᵣ of approx. 310° C. at time t₁ and maintaining this temperature for approx. 2 minutes between times t₁ and t₂ refers to test results in connection with the component B described above; in the case of die-cast parts, however, significantly shorter times or lower temperatures may also be appropriate due to the special microstructure.

The component B is then actively cooled to a removal temperature Tₑ at the second time t₂, in particular before the straightening force Fₘᵢₙ is minimized at the end of straightening, by means of the cooling device 3 (see FIGS. 1 and 2a and b) and can be removed cooled after the straightening process and opening of the pressing tool 1.

By cooling the component B, it is possible for the removal temperature Tₑ and the initial temperature Tₐ of the component B to be essentially the same.

A period of time between the first time t₁ and the second time t₂ can be less than 1200 seconds, preferably less than 30 seconds, more preferably less than 10 seconds.

The maximum straightening force Fₘₐₓ depends on the component and material and is between 0.1 t and 15 t, for example.

As the temperature-time function T(t) and the force-time function F(t) can be set or controlled completely independently of each other, it is possible to optimize the hot straightening process entirely to the component B to be straightened.

For example, it is conceivable that the temperature-time function T(t) also has local minima—as shown in FIG. 4b as an example, in order to heat and/or actively cool a component region less in the meantime.

Rising and falling edges of the temperature-time function T(t) and/or the force-time function F(t) can be set as required.

It is also possible for the force-time function F(t) to be selected such that a vibration, in particular a high-frequency vibration, (oscillating part in FIG. 4b) is exerted on the component B (heated or cooling) by moving the at least one straightening punch 10 (or one of the straightening rams 12) up and down correspondingly quickly. However, a vibration normal to the direction of the straightening force is also favorable—the vibrations accelerate the diffusion of the metal atoms and thus the stress relief.

Preferably, the vibration is applied to the component towards the end of the straightening process (e.g. during a decreasing straightening force), as shown in FIG. 4b.

The vibration relieves residual stresses in the component B (by shaking the component), so that the risk of the component B warping under residual stress after the straightening process is minimized as far as possible.

FIG. 4c shows a further exemplary embodiment of the hot straightening method according to the invention (using the hot straightening device according to the invention).

In this exemplary embodiment, the straightening temperature Tᵣ is only reached in at least one (heated) area of the component B at time t₁ after the component has been subjected to a straightening force F.

In this exemplary embodiment, the tool is first closed, then the component B is heated (at least in some regions) and at the same time a straightening force F is applied (at least locally). Finally, the component B is cooled (optionally actively) (similar to that described in connection with FIG. 4a) and the straightening process is ended so that the component B can be removed.

FIG. 4d shows a further exemplary embodiment of the hot straightening method according to the invention, in which a straightening path of the pressing tool (or the straightening punch 10 and/or a straightening ram 12) is controlled via a predetermined or determinable path-time function or straightening path S(t). The straightening path S(t) can be controlled as required.

This means that the straightening force, straightening path and temperature of the hot straightening process can be controlled independently of each other and in a controlled manner. In this way, the leveling force, leveling path and temperature can be combined in any desired amount and duration.

### LIST OF REFERENCE SIGNS

100, 200, 300 Hot straightening device
1 Pressing tool
2 Component heating element
21, 22, 23 Component heating elements
3 Cooling device
10 Straightening punch
11 Component bed (or straightening punch)
12 Straightening ram
B Component
B₂₁, B₂₂, B₂₃ Component regions
F Straightening force or straightening force axis
S Control unit
Tᵣ Straightening temperature
Tₑ Removal temperature

1. Hot straightening device for hot straightening a component (B), wherein the hot straightening device comprises:
a pressing tool (1) which is designed to accommodate the component (B) and to apply at least one straightening force (F₁, F₂, F₃) to the component and to deform the component, to correct local component nominal dimension deviations, and
at least one component heating element (2) which is designed and arranged to heat the component (B) within the pressing tool (1) to a straightening temperature (Tᵣ) without contact.

2. Hot straightening device according to claim 1, characterized in that the at least one component heating element (2) comprises an electromagnetic heating element.

3. Hot straightening device according to claim 1, characterized in that the at least one component heating element (2) comprises an induction heating element.

4. Hot straightening device according to claim 1, characterized in that the at least one component heating element (2) comprises a radiant heater or a monochromatic radiation source.

5. Hot straightening device according to claim 1, characterized by at least two component heating elements (21, 22) which are designed and arranged in such a way that a first component region (B₂₁) can be heated to a first temperature (T₂₁) and a second component region (B₂₂) can be heated to a second temperature (T₂₂).

6. Hot straightening device according to claim 5, characterized by a cooling device (3) which is designed to cool the component (B) or a component region (B₂₁, B₂₂), by flushing the component (B) or the component region (B₂₁, B₂₂) with a gaseous medium.

7. Hot straightening device according to claim 6, characterized in that the pressing tool (1) comprises at least one straightening punch (10, 11), and the at least one component heating element (2) and/or the cooling device (3) is preferably arranged inside the at least one straightening punch (10, 11), and/or the at least one component heating element (2) is insertable into the pressing tool (1), in an open state of the pressing tool (1).

8. Hot straightening device according to claim 7, characterized in that the pressing tool (1) and/or the at least one straightening punch (10, 11) can be moved in a force-controlled and/or displacement-controlled manner, servo-electrically.

9. Hot straightening device according to claim 7, characterized in that the pressing tool (1) and/or the at least one straightening punch (10, 11) has one or more straightening rams (12), and the one of more straightening rams(s) (12) are independently displaceable in a force-controlled and/or displacement-controlled manner servo-electrically, in order to partially apply the at least one straightening force (F₁, F₂, F₃) to the component (B) and to deform the component.

10. Hot straightening device according to claim 1, characterized in that the pressing tool (1) is formed from electrically non-conductive material, in regions in which the at least one component heating element (2) is arranged and/or in regions in the vicinity of the at least one component heating element (2).

11. Hot straightening device according to claim 6, characterized by a control unit(S) which is designed to control a component temperature or the at least one component heating element (2) and/or a/cooling device (3) via a determinable temperature-time function T(t).

12. Hot straightening device according to claim 11, characterized in that the control unit(S) is designed to control the at least one straightening force (F₁, F₂, F₃) of the pressing tool (1) via a determinable force-time function F(t) and/or at least one straightening path S(t).

13. Hot straightening device according to claim 11, characterized in that it and/or the control unit(S) is designed to measure the component (B) during and/or after straightening.

14. Hot straightening device according to claim 1,
characterized in that it the pressing tool (1) is designed to exert a high-frequency vibration, on the component (B).

15. Hot straightening device according to claim 1,
characterized in that the hot straightening device it is of modular design such that the hot straightening device it can be inserted into an existing pressing machine so that a pressing force of the pressing machine can be used.

16. Hot straightening method for hot straightening a (die-cast) component (B), the method comprises the steps of:
a) introducing a component (B) into a pressing tool (1);
b) non-contact heating of the component (B) to a straightening temperature (Tᵣ);
c) applying a straightening force (F) to the component in order to deform the component (B) to correct local deviations in component dimensions; and
d) removal of the straightened component (B).

17. Hot straightening method according to claim 16,
characterized in that wherein step b) comprises heating the component (B) electromagnetically by induction.

18. Hot straightening method according to claim 16, characterized in that
step b) is carried out before or after step c) or in that steps b) and c) are carried out substantially simultaneously.

19. Hot straightening method according to claim 16, characterized in that the component (B) is a die-cast component comprising an aluminum alloy and/or a magnesium alloy.

20. Hot straightening method according to claim 16, characterized in that wherein a cycle time from step a) to d) is less than 60 seconds.

21. Hot straightening method according to claim 16, characterized in that a component temperature is controlled via a predetermined or determinable temperature-time function T(t) and/or the straightening force (F) of the pressing tool (1) is controlled via a predetermined or determinable force-time function F(t).

22. Hot straightening method according to claim 16, characterized in that the component (B) is heated in such a way that it reaches the straightening temperature (Tᵣ) at a first time (t₁) before the straightening force (F) becomes maximum.

23. Hot straightening method according to claim 16, characterized in that the component (B) is actively cooled to a removal temperature (Tₑ) at a second time (t₂) before the straightening force (F) becomes minimum at the end of the straightening, and/or the removal temperature (Tₑ) of the component (B) is less than 1/10 of the maximum straightening temperature (Tᵣ).

24. Hot straightening method according to claim 16, characterized in that the component (B) has an initial temperature (Tₐ) on insertion which essentially corresponds to a room temperature between 15° C. and 35° C., and/or the straightening temperature (Tᵣ) is between 40% and 50% of a melting point temperature of the material of the component (B), and/or the straightening temperature (Tᵣ) is between 230° C. and 450° C.

25. Hot straightening method according to claim 16, characterized in that step c) comprises exerting a a high-frequency vibration, on the component (B) towards the end of step c.
